(19) United States
(12) Patent Application Publication
(10) Pub. No.: US 2016/0235233 A1
(43) Pub. Date: Aug. 18, 2016

(54) MOLDED COMPOSITE GARMENT HANGER AND MOLDS FOR MANUFACTURING THE SAME

(71) Applicant: Keter Plastic Ltd., Herzelyia (IL)

(72) Inventors: Nir APELBAUM, Tel Aviv (IL); Efraim HAIMOFF, Mevaseret Zion (IL)

(21) Appl. No.: 15/041,549

(22) Filed: Feb. 11, 2016

Related U.S. Application Data
(60) Provisional application No. 62/115,321, filed on Feb. 12, 2015.

(51) Int. Cl. A47G 25/32; B29C 45/26; B29C 45/00; A47G 25/30; B29C 45/16

(52) U.S. Cl. CPC A47G 25/32; A47G 25/30; B29C 45/1635; B29C 45/0017; B29C 45/26; B29L 2031/735

(57) ABSTRACT

The disclosed subject matter is directed to a composite garment hanger. The hanger includes a hanger body and a rotatable hook component, the rotatable hook component being integrally formed by injection molding with the hanger body in a movable relationship therewith, where at least a portion of the hanger body overlaps with the rotatable hook, the hanger being formed from a composite material.

### TECHNOLOGICAL FIELD

The disclosed subject matter is directed towards plastic hangers and associated molds.

### BACKGROUND ART

Reference considered to be relevant as background to the presently disclosed subject matter is listed below:
WO05123361

Acknowledgement of the reference mentioned hereinabove is not to be inferred as meaning that it is in any way, shape or form relevant to the patentability of the presently disclosed subject matter.

### GENERAL DESCRIPTION

The presently disclosed subject matter pertains to a molded garment hanger comprising a hanger body and a rotatable hook component, the rotatable hook component being integrally formed with the garment hanger. In accordance with the disclosed subject matter the hanger is molded in a multi shot molding process by injecting at least a first thermoplastic material and a thermoplastic second material, the second material being injected in an overlapping though movable relationship to the first material. The at least two materials are injection molded such that they do not bond during the injection molding process although they are structured to at least partially overlap to engage each other and move, e.g. rotate, one with respect to the other. In accordance with an example, the first material can be acetal, nylon 6, nylon 6,6 and the like while the second material can be polypropylene, polycarbonate, polyethylene and the like; or vice versa.

The presently disclosed subject matter is further directed to a mold and a molding process for molding at least two materials that do not bond to each other while allowing at least one degree of freedom between the two. In accordance with an example, at least two degrees of freedom are allowed, e.g. rotation of one part within the second part around an axis and a linear motion along the axis.

The mold in accordance with an example is a dynamic mold, comprising a movable insert configured to hold at least a first position during the molding process of the first part and at least a second position during the molding process of the second part. The mold in accordance with the disclosed subject matter has a main relief defining a shape of the molded article and a secondary relief defining a shape of an element engaged with and movable with respect to the article, the mold further comprising a dynamic insert, configured to hold a first position while constituting a portion in the secondary relief and a second position in which the insert forms part of the main relief. In accordance with an example, the main relief defines a hanger body and the secondary relief defines a hanger hook portion and wherein the hanger body and the hook are molded such that the hook is configured to rotate within an opening extending at a top portion of the hanger body.

In accordance with the disclosed subject matter there is provided a mold comprising a first mold side and a second mold side together defining a relief in the desired shape, e.g. a hanger. The mold further comprises a dynamic insert comprising a first portion associated with and complementing the first mold side and a second portion, associated with and complementing a second mold side, such that the dynamic insert in a first position defines a relief in the shape of at least a portion of a first, movable part and in a second position, the dynamic insert is moved to define a relief shaped around at least the portion of the first part, such that when the second material is injected that does not bond with the first material injected, the two parts are movably engaged.

In an aspect of the disclosed subject matter there is provided a garment hanger, comprising a hanger body and a rotatable hook component, the rotatable hook component being integrally formed by injection molding with the hanger body in a movable relationship therewith, wherein at least a portion of the hanger body overlaps with the hook, the hanger being formed from a composite material.

In one embodiment, the rotatable hook is configured to freely rotate relative the hanger body through an opening at its top central portion. In accordance with an example of this embodiment the hook comprises a hooked end and an engagement end, the engagement end being configured to be received within the opening in the hanger body.

In an embodiment of the disclosed subject matter the engagement end comprises an engagement pin and top shoulder and bottom shoulder portions, which when received within the opening prevent the engagement end from spontaneous release therefrom, constituting restraining portions and wherein further allowing relative movement of the pin within the opening.

A garment hanger in accordance with the disclosed subject matter is comprised of a composite material, wherein in one embodiment the composite material of the hanger body is comprised of a first thermoplastic material different from a second thermoplastic material of the hook, the first material and the second material being injection molded in such a way that they do not bond during the injection molding process.

In accordance with an embodiment, the hanger body is comprised of a first material different from the second material of the hook, the first material and the second material being injection molded in such a way that they do not bond during the injection molding process.

In accordance with an embodiment, the hanger body is further provided with integrally molded anti skid elements, wherein the anti skid elements are comprised of a third material.

In accordance with yet an aspect of the disclosed subject matter there is provided a mold having a main relief defining a shape of the article and a secondary relief defining a shape of an element engaged with and movable with respect to the article, the mold further comprising a dynamic insert, configured to hold a first position while constituting a portion in the secondary relief and a second position in which the insert forms part of the main relief.

In accordance with an embodiment, the main relief defines a hanger body and the secondary relief defines a hanger hook portion and wherein the hanger body and the hook are molded from a composite material such that the hook is configured to rotate within an opening extending at a top portion of the hanger body.

In accordance with an embodiment of the disclosed subject matter, the mold has a separate injection channel for each of at least the hanger body and a hook, the channels being isolable one from the other by said dynamic insert.

The mold in an embodiment of the disclosed subject matter allows injecting at least a first material and a second material, wherein injecting said first material and injecting said second material are performed within a single molding cycle. In one example the injection of said second material is performed while said first material is cooling.

In accordance with yet an embodiment, the mold allows injecting at least a first material and a second material, wherein injecting said first material and injecting said second material are performed within a single molding cycle and the injection of said first and second materials is performed simultaneously, but wherein said second material does not contact said first material until said first material has begun to cool.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a perspective view of a hanger in accordance with an example of the disclosed subject matter;

FIG. 2 is a cross section taken along C-C seen in FIG. 1 in accordance with an example of the disclosed subject matter;

FIG. 3 is a bottom perspective view of the hook of FIG. 1 in accordance with an example of the disclosed subject matter;

FIG. 4 is a top perspective view of the hanger body of FIG. 1;

FIGS. 5A to 5D, illustrate consecutive steps in the molding process of the hanger of FIG. 1, centered on a portion of the mold constituting the central portion of the hanger; and

FIG. 5E is an additional step in the molding process in accordance with an example of the disclosed subject matter, illustrating the movement of the inserts to expose the relief for the injection of a third material.

### DETAILED DESCRIPTION OF EMBODIMENTS

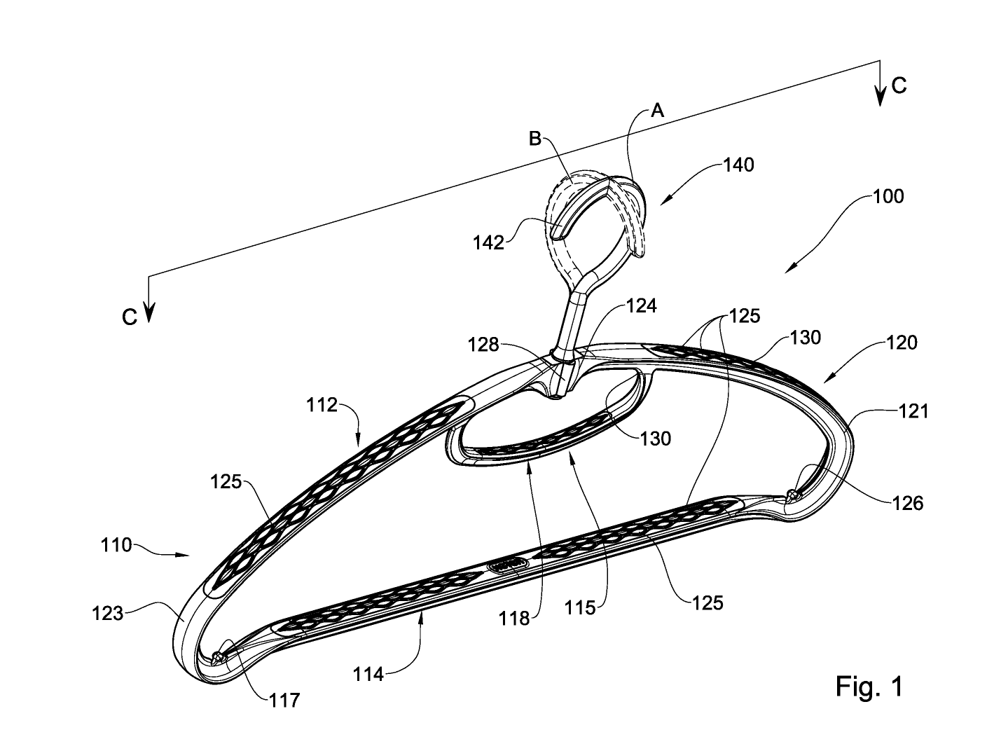

The presently disclosed subject matter pertains to a molded garment hanger seen in FIG. 1 where it is generally designated 100. The hanger 100 comprises a hanger body 120 and a rotatable hook component 140, the rotatable hook 140 component being integrally formed and extending through the hanger 120. The hanger comprises a closed circle body 110, having a top 112 bar and a bottom bar 114, a central section 115 and two arm portions 121 and 123 extending outwards from the central section 115 and configured for holding a garment thereon. The hanger is further provided with garment engaging elements 117 at its lower bar 114. The top bar 112 is provided with an extension 118 configured for holding ties, scarves, etc. To prevent slippage of the garment(s) from the hanger or its portions, anti skid elements 125 are provided. In this example, the hanger is provided with rubber surfaces which cause friction and prevent slippage. It will be appreciated that other types of anti skid elements can be featured, such as protrusions, indentations, high friction fabrics, etc. As will be discussed, in the illustrated example, the rubber surface is provided during the multi stage molding process of the hanger 100.

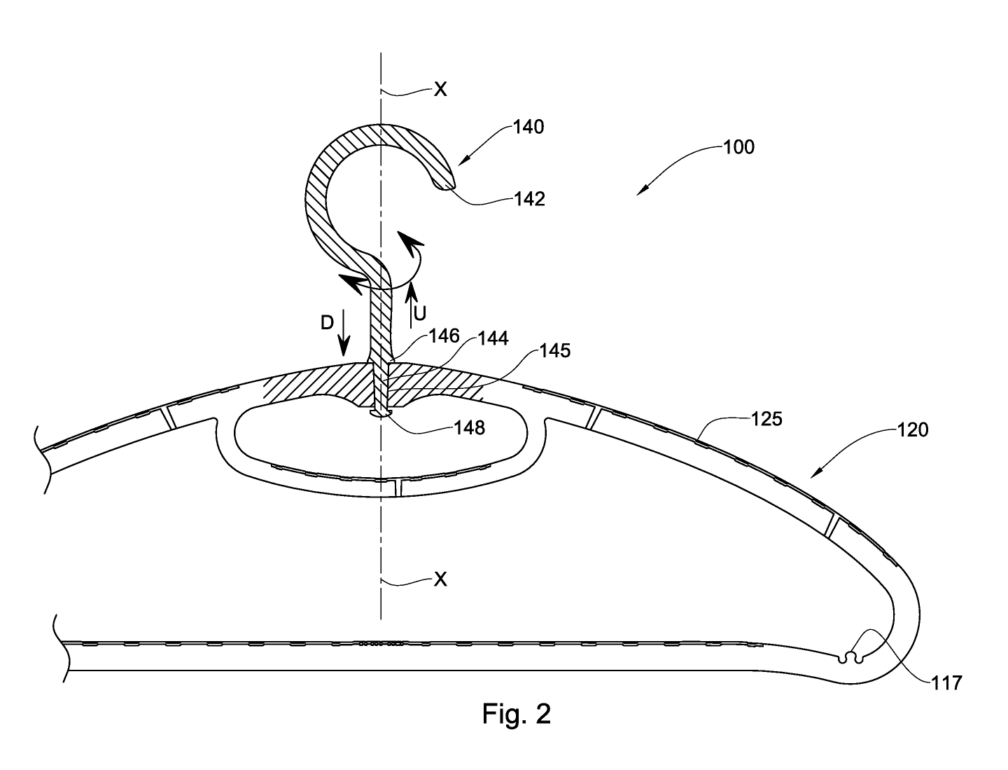

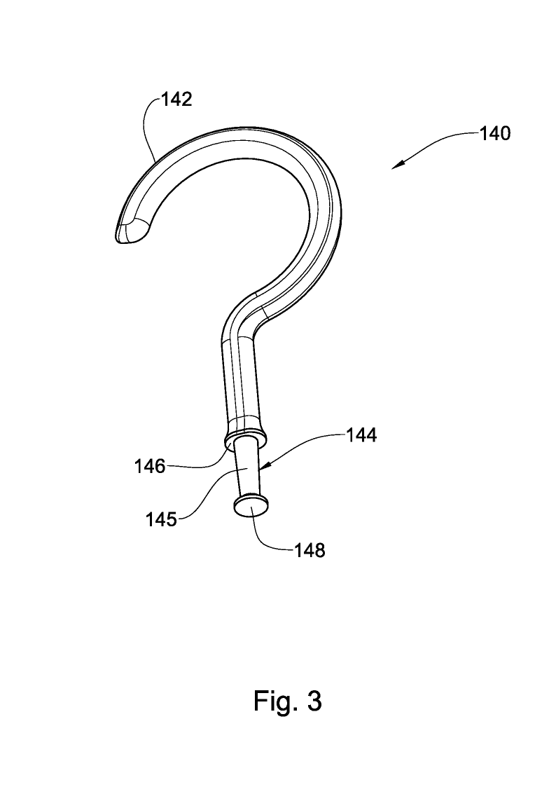

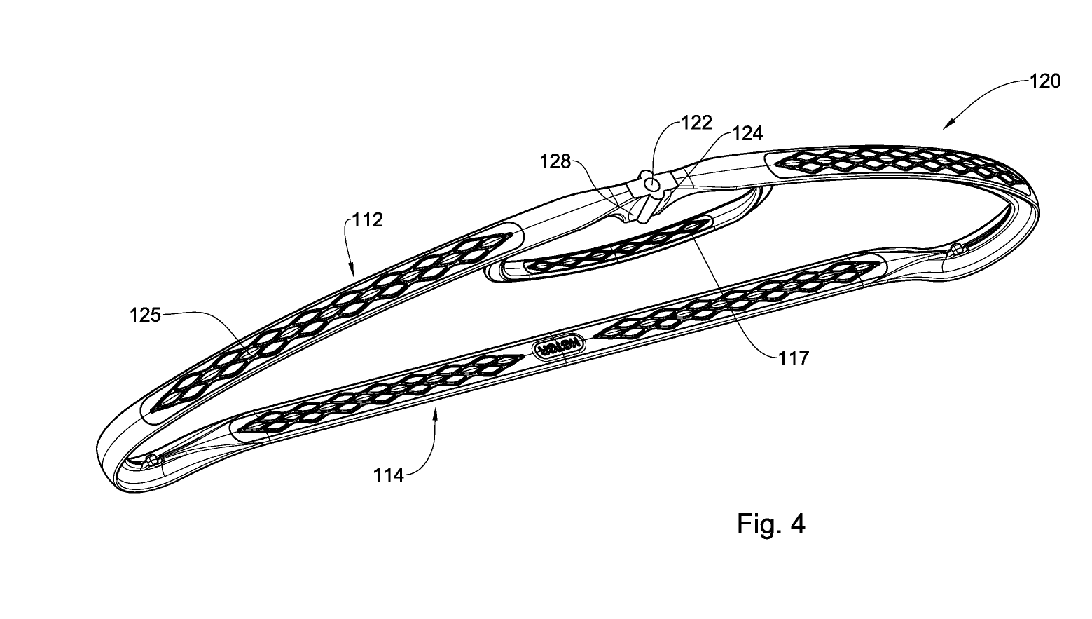

The hook 140 is configured to freely rotate relative the hanger body 120, i.e. through an opening 122 (seen best, e.g. in FIGS. 2 and 4) at its top central portion 115. As best seen in FIG. 2, the hook comprises a hooked end 142 and an engagement end 144. The engagement end is configured to be received within the opening 122 in the hanger body 120. As seen in this figure as well as in FIG. 3, the engagement end 144 comprises an engagement pin 145 and top 146 shoulder and bottom 148 shoulder portions, which when received within the opening 122 prevent the engagement end from spontaneous release therefrom constituting restraining/arresting portions. The top shoulder portion 146 prevents movement in the downward direction D and the bottom shoulders prevent upward movement in the direction U. The width or the diameter of the engagement pin is smaller than that of the opening 122 and thus although securely held in place, the hook can rotate within the opening and, if desired, can have an additional degree of freedom allowing it to axially move along the axis X although constrained by the top and bottom shoulders. Rotational movement is illustrated by the positions A and B of the hook illustrated in FIG. 1.

In accordance with the disclosed subject matter, the hanger is constructed in a multi shot molding process by injecting at least a first material and a second material. The at least two materials are injection molded in such a way that they do not bond during the injection molding process, although they are molded to at least partially overlap to engage each other and move, e.g. rotate, one within the other. In accordance with an example, the first material can be a nylon, acetal and the like while the second material can be polypropylene, polycarbonate or the like. The first material can be used for the hook member and the second material to form the hanger.

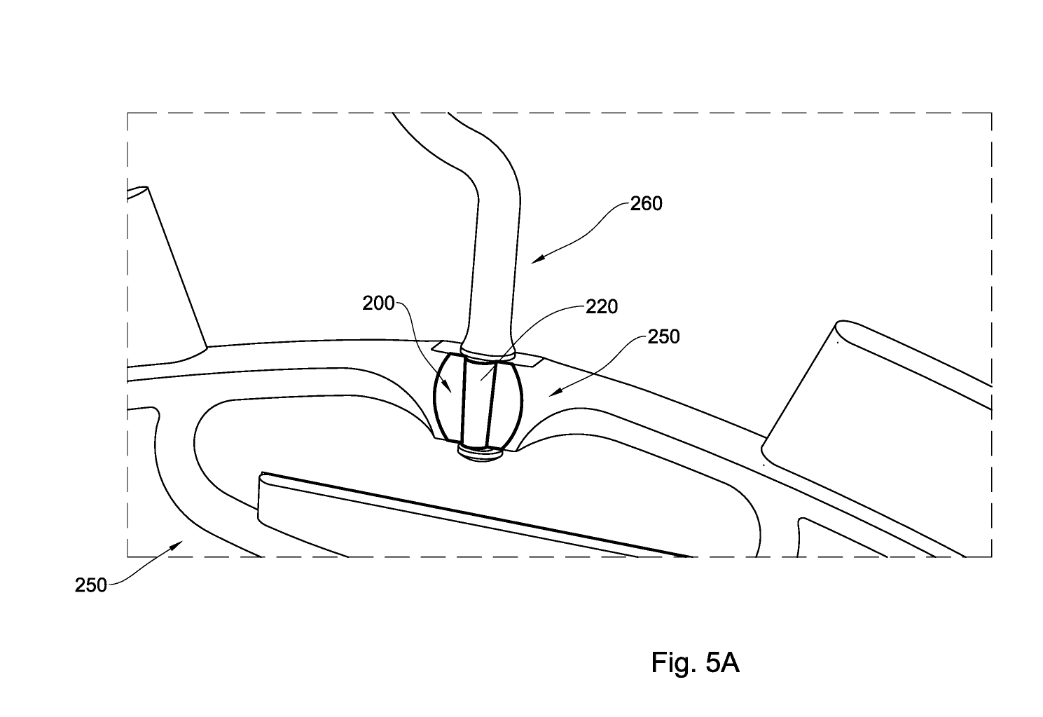

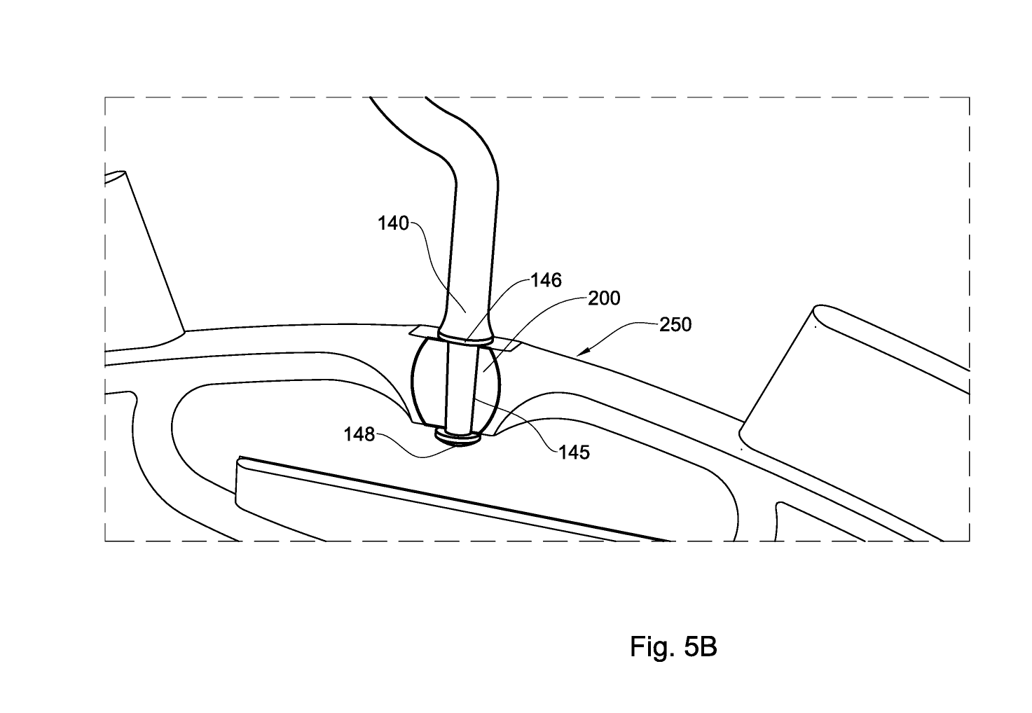

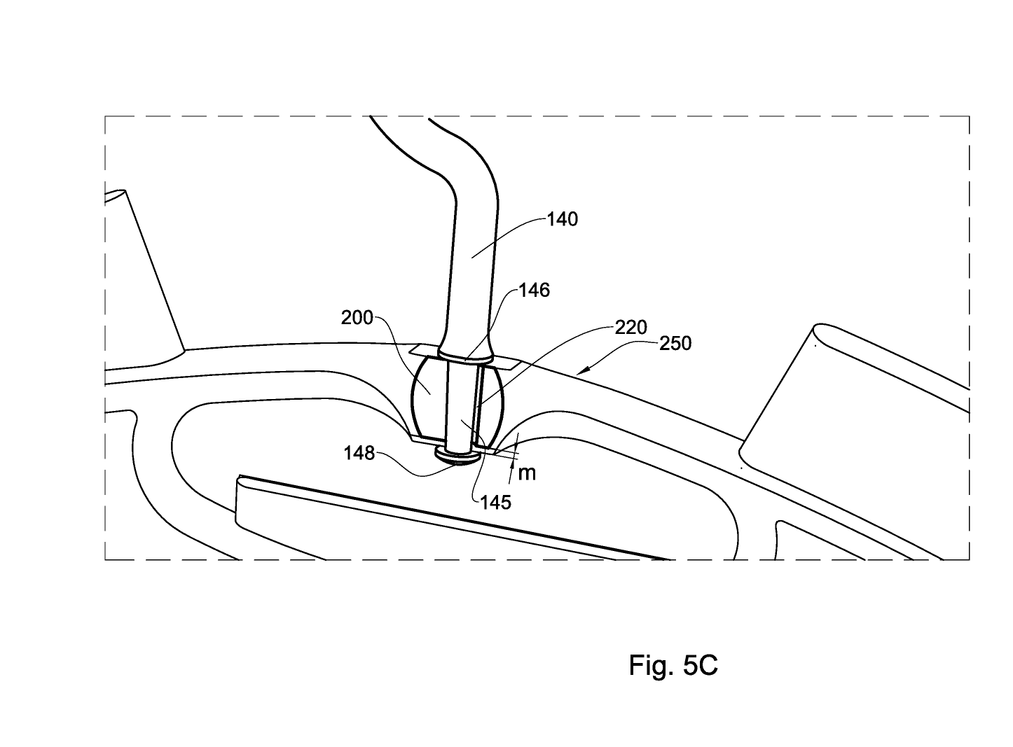

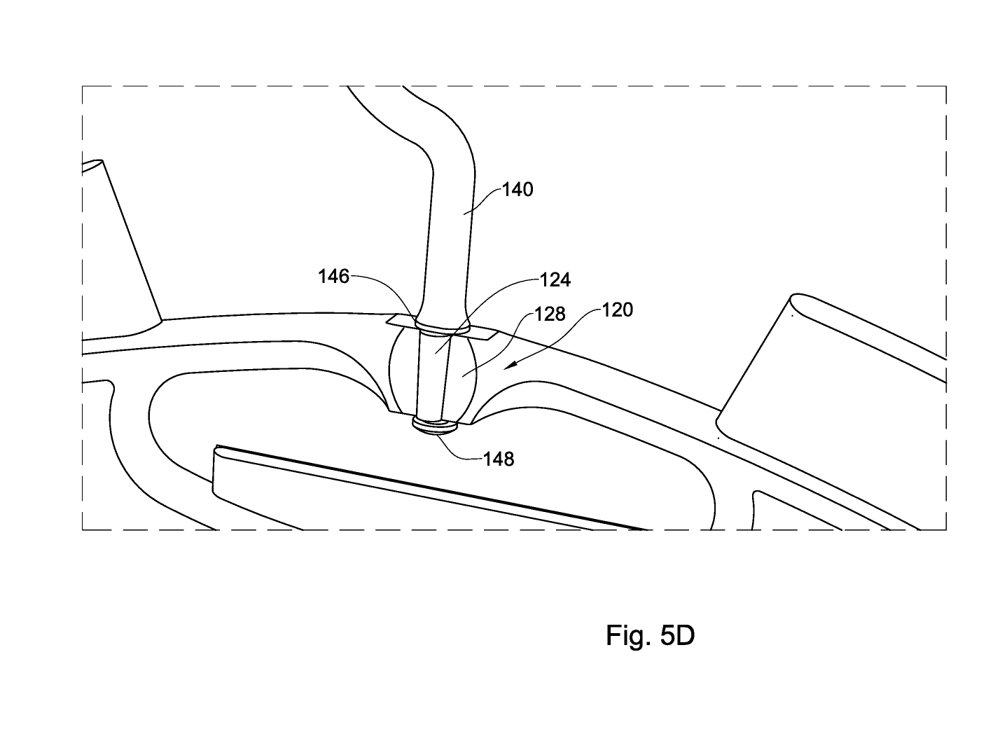

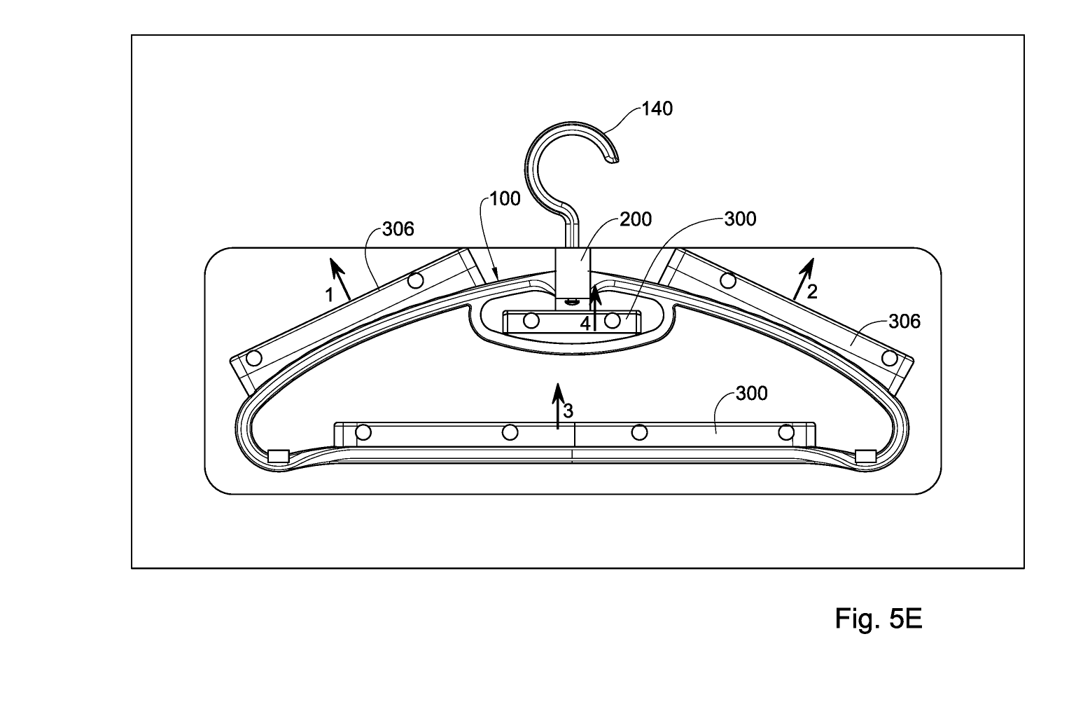

The mold used to manufacture the hanger 100 in accordance with an example is a dynamic mold, comprising a movable insert configured to hold at least a first position during the molding process of the first part and at least a second position during the molding process of the second part. The mold and the method of manufacturing a hanger in accordance with an example of the disclosed subject matter will be described with reference to FIGS. 5A-5E. FIG. 5A illustrates a portion of one side of a mold showing the dynamic insert generally designated 200. The mold generally comprises a first mold side and a second mold side which together define a relief in the desired shape, e.g. a hanger. FIG. 5A illustrates a portion of one side of said relief, the other side being complementary in shape. As can be seen in FIGS. 5A to 5C, the mold comprises a main relief 250 which defines the structure of the hanger (e.g. 100) and a secondary relief 260 which defines the hook structure (e.g. 140). The dynamic insert 200 comprises a first portion seen in FIG. 5A which is associated with and complementary to a first mold side and a second portion (not shown), associated with and complementing a second mold side (not shown), such that the dynamic insert in a first position defines a relief 220 in the shape of the engagement pin 145, and in a second position (seen and described with reference to FIG. 5C) the dynamic insert is moved to define a relief shaped around the at least engagement pin 145, such that when the second material is injected, the two parts are movably engaged.

During the molding process, a first material, e.g. acetal, is injected into the secondary relief 260 to form the hook portion (e.g. 140). The material flows through the relief in the insert 200, i.e. the cavity 220, the shape of which constitutes the mold for the engagement pin 145 (seen best in FIG. 5B). As the first material sets, the insert 200 is moved in a direction m away from the material, complementing the main relief 250 of the hanger mold. By complementing it is meant that the dynamic insert forms part of the main mold relief which constitutes for example the shape of the hanger. As shown in FIG. 5C, the relief 220 in the insert 200, now part of the main mold 250, contributes to the protrusion 124 shaped on the central portion 128 of the hanger 100, seen for example in FIGS. 1 and 5D.

After the insert 200 is moved away from the first injected material, the second material, e.g. polypropylene, is injected into the main mold cavity 250. The properties of the materials prevent bonding therebetween thus the first material remains unattached to the second material, which imparts it with the rotational and axial movements within the opening formed by the second material molded therearound.

FIG. 5E illustrates an additional step in the molding process. In this step, preparation is made to inject a third material to constitute the anti skid surfaces 125 in the hanger 100. Such material can be any type of material having properties preventing slippage of a garment, such as rubber, silicone etc having a relatively high friction coefficient. It will be appreciated that alternatively, the anti skid surface can be formed by the same material as the hanger body by providing a non smooth surface, e.g. a ridged pattern or any other pattern as desired. For the step of injecting the third material, inserts 300 covering the relief constituting the respective surfaces are moved away and the third material, such as a rubber is injected and bonded to the hanger, i.e. the second material.

It will be appreciated that while the disclosure refers to a hanger, the mold structure and the method can be used to manufacture other articles, including different shapes of hangers, etc. where it is needed that at least one part remains engaged with, but movable with respect to another part.

1. A garment hanger, comprising:
a hanger body; and
a rotatable hook component, the rotatable hook component being integrally formed by injection molding with the hanger body in a movable relationship therewith,
wherein at least a portion of the hanger body overlaps with the rotatable hook, the hanger being formed from a composite material.

2. The garment hanger in accordance with claim 1, wherein the rotatable hook is configured to freely rotate relative the hanger body through an opening at its top central portion.

3. The garment hanger in accordance with claim 1, wherein the rotatable hook is configured to freely rotate relative the hanger body through an opening at its top central portion and wherein the hook comprises a hooked end and an engagement end, the engagement end being configured to be received within the opening in the hanger body.

4. The garment hanger in accordance with claim 1, wherein the rotatable hook is configured to freely rotate relative the hanger body through an opening at its top central portion, and wherein the hook comprises a hooked end and an engagement end, the engagement end being configured to be received within the opening in the hanger body, the engagement end comprising an engagement pin and top shoulder and bottom shoulder portions, which when received within the opening prevent the engagement end from spontaneous release therefrom, constituting restraining portions and wherein further allowing relative movement of the pin within the opening.

5. The garment hanger in accordance with claim 1, wherein the composite material of the hanger body comprises a first thermoplastic material different from a second thermoplastic material of the hook, the first material and the second material being injection molded in such a way that they do not bond during the injection molding process.

6. The garment hanger in accordance with claim 1, wherein the hanger body comprises a first material different from a second material of the hook, the first material and the second material being injection molded in such a way that they do not bond during the injection molding process.

7. The garment hanger in accordance with claim 1, wherein the hanger body further comprises integrally molded anti-skid elements.

8. The garment hanger in accordance with claim 1, wherein the hanger body further comprises integrally molded anti-skid elements, wherein the anti-skid elements are comprised of a third material.

9. A mold, comprising:
a main relief defining a shape of the article;
and a secondary relief defining a shape of an element engaged with and movable with respect to the article; and
a dynamic insert, configured to hold a first position while constituting a portion in the secondary relief and a second position in which the insert forms part of the main relief.

10. The mold of claim 9, wherein, the main relief defines a hanger body and the secondary relief defines a hanger hook portion and wherein the hanger body and the hook are molded such that the hook is configured to rotate within an opening extending at a top portion of the hanger body.

11. The mold of claim 9, wherein the mold has a separate injection channel for each of at least a hanger body and a hook, the channels being isolable one from the other by said dynamic insert.

12. The mold of claim 9, wherein the mold allows injecting at least a first material and a second material, wherein injecting said first material and injecting said second material are performed within a single molding cycle.

13. The mold of claim 9, wherein the mold allows injecting at least a first material and a second material, wherein injecting said first material and injecting said second material are performed within a single molding cycle, such that the injection of said second material is performed while said first material is cooling.

14. The mold of claim 9, wherein the mold allows injecting at least a first material and a second material, wherein injecting said first material and injecting said second material are performed within a single molding cycle and the injection of said first and second materials is performed simultaneously, but wherein said second material does not contact said first material until said first material has begun to cool.
